(19) United States
(12) Patent Application Publication
(10) Pub. No.: US 2026/0292475 A1
(43) Pub. Date: Sep. 24, 2026

(54) REPORT INFORMATION STORAGE METHOD, ELECTRONIC DEVICE AND COMPUTER-READABLE MEDIUM

(71) Applicant: SANECHIPS TECHNOLOGY CO., LTD., Nanshan District, Shenzhen, Guangdong (CN)

(72) Inventor: Jun LI, Shenzhen, Guangdong (CN)

(21) Appl. No.: 18/996,062

(22) PCT Filed: Jun. 27, 2023
(86) PCT No.: PCT/CN2023/102619

§ 371 Date: Jan. 17, 2025

(30) Foreign Application Priority Data
Aug. 23, 2022 (CN) 202211022182.3

(51) Int. Cl. H04W 8/20

(52) U.S. Cl. CPC H04W 8/205

(57) ABSTRACT

The present disclosure provides a report information storage method, an electronic device, and a computer-readable medium. The report information storage method includes: receiving a first message, which includes first resource configuration information and first report configuration information; allocating a first storage space according to the first report configuration information, with a size of the first storage space obtained by calculation based on the quantity of the first report configuration information; and storing first report information obtained by calculation based on the first resource configuration information and the first report configuration information in the first storage space.

### CROSS-REFERENCE TO RELATED APPLICATIONS

The present disclosure claims the priority to Chinese Patent Application No. 202211022182.3 filed with the CNIPA on Aug. 23, 2022, the contents of which are incorporated herein by reference in their entirety.

### TECHNICAL FIELD

The present disclosure relates to, but is not limited to, the technical field of mobile communications.

### BACKGROUND

In the Channel State Information (CSI) of the New Radio (NR) technology, a next generation base station (i.e., the next Generation Node B, gNB) configures, through Radio Resource Control (RRC) layer signaling, N≥1 pieces of CSI resource configuration (CSI-ResourceConfig) information (the CSI resource configuration information includes configuration information of resources such as the Non Zero Power-Channel State Information-Reference Signal-Resource (NZP-CSI-RS-Resource) and the Channel State Information-Instant Messaging-Reference Signal-Resource (CSI-IM-Resource)), M≥1 pieces of CSI report configuration (CSIReportConfig) information, and one or two state trigger linked lists for a User Equipment (UE), and the configuration information may be carried in an LINR_P_DEDICATED_CONFIG_REQ message. After a physical layer of the UE receives the LINR_P_DEDICATED_CONFIG_REQ message, the physical layer of the UE may process the LINR_P_DEDICATED_CONFIG_REQ message. In order to store the CSI resource configuration information carried in the LINR_P_DEDICATED_CONFIG_REQ message, an NZP-CSI-RS-Resource resource node and a CSI-IM-Resource resource node for storage and registration may be created in NR physical layer code. The created resource nodes are configured to store the CSI resource configuration information and report information, but the utilization of a storage space is low in existing storage methods.

### SUMMARY

The present disclosure provides a report information storage method, an electronic device, and a computer-readable medium.

In a first aspect, the present disclosure provides a report information storage method, including: receiving a first message; wherein the first message includes first resource configuration information and first report configuration information; allocating a first storage space according to the first report configuration information; wherein a size of the first storage space is obtained by calculation based on a quantity of the first report configuration information; and storing first report information obtained by calculation based on the first resource configuration information and the first report configuration information in the first storage space.

In a second aspect, the present disclosure provides an electronic device, including: at least one processor; and a storage device having stored thereon at least one program which, when executed by the at least one processor, implements the report information storage method described above.

In a third aspect, the present disclosure provides a computer-readable medium having stored thereon a computer program which, when executed by a processor, implements the report information storage method described above.

### BRIEF DESCRIPTION OF DRAWINGS

FIG. 1 is a flowchart illustrating a report information storage method according to the present disclosure; and

FIG. 2 is a schematic diagram illustrating searching for a storage unit for report information according to the present disclosure.

### DETAIL DESCRIPTION OF EMBODIMENTS

In order to enable those of ordinary skill in the art to better understand the technical solutions of the present disclosure, a report information storage method, an electronic device, and a computer-readable medium provided by the present disclosure are described in detail below with reference to the drawings.

Exemplary implementations of the present disclosure will be described more fully below with reference to the drawings, but the exemplary implementations described herein may be embodied in different forms and should not be interpreted as being limited to the implementations described herein. Rather, the implementations are provided to make the present disclosure thorough and complete, and may enable those of ordinary skill in the art to fully understand the scope of the present disclosure.

The implementations described herein and the features therein can be combined with one another if no conflict is incurred.

The term “and/or” used herein includes any and all combinations of at least one associated listed item.

The terms used herein are merely used to describe specific implementations, and are not intended to limit the present disclosure. As used herein, “a” and “the” which indicate a singular form are intended to include a plural form, unless expressly stated in the context. It should be further understood that the term(s) “include” and/or “be made of” used herein indicate(s) the presence of the described features, integers, operations, elements and/or components, but do not exclude the presence or addition of at least one other feature, integer, operation, element, component and/or combinations thereof.

Unless otherwise defined, all terms (including technical and scientific terms) used herein have the same meaning as commonly understood by those of ordinary skill in the art. It should be further understood that terms, such as those defined in commonly used dictionaries, should be interpreted as having a meaning that is consistent with a meaning in the context of the related technology and the background of the present disclosure, and should not be interpreted in an idealized or overly formal sense unless expressly so defined herein.

After receiving the LINR_P_DEDICATED_CONFIG_REQ message, the UE may establish an association relationship between periodic resources and periodic reports. At this time, a storage space needs to be allocated for the periodic reports in the resource nodes and is configured to store the report information which is obtained by calculation based on the CSI resource configuration information and the CSI report configuration information and is reported periodically, and the allocated storage space is always occupied and is not changed until the LINR_P_DEDICATED_CONFIG_REQ message is received again next time. However, if a Media Access Control Control Element (MACCE) message or a Downlink Control Information (DCI) message is received during a periodic report, a semi-persistent report or a non-periodic report may be activated, at this time, an additional storage space needs to be allocated in the resource nodes.

At present, what can be met is merely a service scenario in which a single carrier is involved and a report is uniquely associated with a resource. With continuous expansion of service scenarios, a service scenario in which multiple carriers are involved and a plurality of reports correspond to one resource needs to be met. If the resource configuration information and the report information of all reports associated with the resources are stored in the resource nodes, a risk of stack overflow may occur when a local variable of the resource nodes is applied, and a large number of storage spaces need to be occupied, but since all the storage spaces are not in a use state all the time, the utilization of the storage spaces is low.

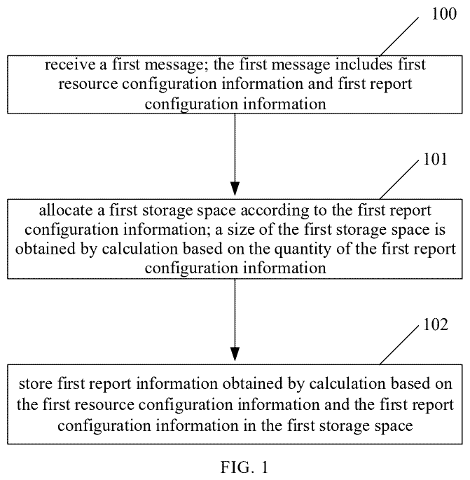

FIG. 1 is a flowchart illustrating a report information storage method according to the present disclosure.

In a first aspect, referring to FIG. 1, the present disclosure provides a report information storage method, including operations 100 to 102.

At operation 100, a first message is received; and the first message includes first resource configuration information and first report configuration information.

In some exemplary implementations, the first resource configuration information may include: at least one of a time frequency position of a resource, a period and offset, the number of ports, or a density.

In some exemplary implementations, the first report configuration information may include: at least one of a report identification, a resource configuration identification of an RS resource for channel measurement, a resource configuration identification of an IM resource for interference measurement, a resource configuration identification of an RS resource for interference measurement, a report period and offset, report quality, or codebook configuration.

In some exemplary implementations, the report quality is configured to indicate information which needs to be reported.

In some exemplary implementations, the first message includes: at least one of a dedicated configuration request message, an MACCE message, or a DCI message.

In some exemplary implementations, the dedicated configuration request message is an LINR_P_DEDICATED_CONFIG_REQ message.

In some exemplary implementations, an order of receiving the dedicated configuration request message, the MACCE message, and the DCI message is not limited. For example, the dedicated configuration request message may be received first, with the dedicated configuration request message being capable of triggering a periodic report, and then the MACCE message or the DCI message may be received, with the MACCE message or the DCI message being capable of triggering a semi-persistent report, and the DCI message being capable of triggering a non-periodic report.

At operation 101, a first storage space is allocated according to the first report configuration information; and a size of the first storage space is obtained by calculation based on the quantity of the first report configuration information.

In some exemplary implementations, the first storage space is different from a storage space allocated to the resource nodes. That is, the first storage space is a storage space separated from the resource nodes and dedicated to report information storage.

In some exemplary implementations, first report information includes: at least one of a Channel Quality Indicator (CQI), a layer indicator, a rank indicator, or a precoding indicator.

In some exemplary implementations, the quantity of the first report configuration information refers to the number of reports configured by the first report configuration information.

In some exemplary implementations, the size of the first storage space is a product of the quantity of the first report configuration information, the number of supported carriers, and a size of a second storage space which is occupied by each piece of first report information.

At operation 102, the first report information obtained by calculation based on the first resource configuration information and the first report configuration information is stored in the first storage space.

In some exemplary implementations, in a case where a scheduling time of a resource configured by the first resource configuration information is reached, Digital Front End (DFE) data of the resource is acquired according to the information such as the time frequency position of the resource and the number of ports, and a channel response matrix H and a noise matrix R are calculated based on the DFE data; a Signal to Noise Ratio (SNR) is calculated based on the channel response matrix H and the noise matrix R; and the first report information is calculated based on the SNR and the report quality.

In some exemplary implementations, storing the first report information obtained by calculation based on the first resource configuration information and the first report configuration information in the first storage space includes: calculating a first storage unit identification by a hash function based on a preset identification corresponding to the first report information; and in a case where a storage unit corresponding to the first storage unit identification is idle, storing the first report information in the storage unit corresponding to the first storage unit identification; and the first storage space is divided into at least one storage unit, and a size of the storage unit is a size of the second storage space which is occupied by one piece of first report information in the first storage space.

In some exemplary implementations, the preset identification is a report identification or a resource identification.

In some exemplary implementations, calculating the first storage unit identification by the hash function based on the preset identification corresponding to the first report information includes: taking a remainder obtained by dividing the preset identification by the number of the storage units included in the first storage space as the first storage unit identification.

In some exemplary implementations, in a case where the storage unit corresponding to the first storage unit identification is occupied, storing the first report information obtained by calculation based on the first resource configuration information and the first report configuration information in the first storage space further includes: calculating a second storage unit identification by a rehash function based on the preset identification corresponding to the first report information; and in a case where a storage unit corresponding to the second storage unit identification is idle, storing the first report information in the storage unit corresponding to the second storage unit identification.

In some exemplary implementations, calculating the second storage unit identification by the rehash function based on the preset identification corresponding to the first report information includes: adding i to the preset identification, with i being an integer greater than or equal to 1; and taking a remainder obtained by dividing the preset identification with the addition of i by the number of the storage units included in the first storage space as the second storage unit identification.

In some exemplary implementations, in a case where the storage unit corresponding to the second storage unit identification is occupied, storing the first report information obtained by calculation based on the first resource configuration information and the first report configuration information in the first storage space further includes: performing an operation of calculating a third storage unit identification by the rehash function based on the preset identification corresponding to the first report information until a storage unit corresponding to a calculated storage unit identification is idle.

It should be noted that, each time the storage unit identification is calculated by the rehash function, the selected value of i is desired to be different from all the values of i that are selected for previous times of calculating the storage unit identification by the rehash function. For example, when the storage unit identification is calculated by the rehash function for the first time, i=1; when the storage unit identification is calculated by the rehash function for the second time, i=2; when the storage unit identification is calculated by the rehash function for the third time, i=3; and so on, until the storage unit corresponding to the calculated storage unit identification is idle.

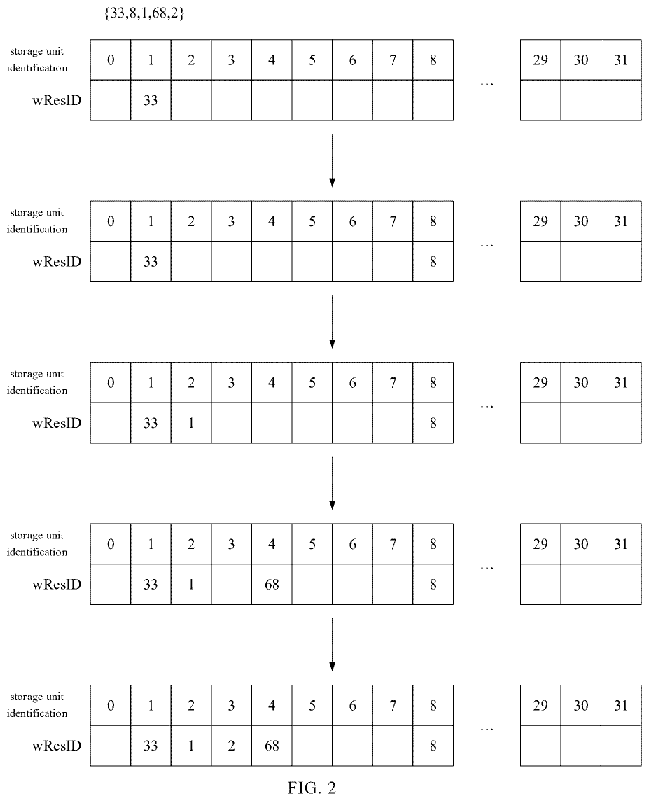

For example, as shown in FIG. 2, it is assumed that the first report information corresponding to 5 reports needs to be stored at a current moment, and corresponds to resource identifications {33, 8, 1, 68, 2} respectively, and the number of the storage units included in the first storage space allocated for reports is 32, that is, the first report information corresponding to 32 reports can be stored at most. Then, the hash function is f(wResID)=wResID mod 32, where wResID denotes the resource identification. The following is a process of searching for an idle storage unit by the hash function and the rehash function.
(1) Searching for a storage unit for the first report information corresponding to the resource with wResID=33: by use of a hash function f (wResID)=wResID mod m, where m=32, a calculation is performed by the hash function as f(33)=33 mod 32=1, and the storage unit 1 is idle, so the first report information is stored in a memory where the storage unit 1 is located.
(2) Searching for a storage unit for the first report information corresponding to the resource with wResID=8: a calculation is performed by the hash function as f(8)=8 mod 32=8, and the storage unit 8 is idle, so the first report information is stored in a memory where the storage unit 8 is located.
(3) Searching for a storage unit for the first report information corresponding to the resource with wResID=1: a calculation is performed by the hash function as f(1)=1 mod 32=1, but the storage unit 1 is occupied, that is, a hash collision occurs, so an idle storage unit is searched for by the rehash function, i.e., f(1)=[f(1)+d] mod m, where a value of d ranges from 1 until the idle storage unit is found; and when d=1, a calculation is performed as f(1)=[f(1)+1] mod 2=2, and the storage unit 2 is idle, so the first report information is stored in the storage unit 2.
(4) Searching for a storage unit for the first report information corresponding to the resource with wResID=68: a calculation is performed by the hash function as f(68)=68 mod 32=4, and the storage unit 4 is idle, so the first report information is stored in a memory where the storage unit 4 is located.
(5) Searching for a storage unit for the first report information corresponding to the resource with wResID=2: a calculation is performed by the hash function as f2=2 mod 32=2, but the storage unit 2 is occupied, that is, a hash collision occurs, so an idle storage unit is searched for by the rehash function, i.e., f(2)=[f(2)+d] mod m, where a value of d ranges from 1 until the idle storage unit is found; and when d=1, a calculation is performed as f(1)=[f(2)+1] mod 32=3, and the storage unit 3 is idle, so the first report information is stored in the storage unit 3.

In some exemplary implementations, after storing the first report information obtained by calculation based on the first resource configuration information and the first report configuration information in the first storage space, the method further includes: receiving a second message, which includes second resource configuration information and second report configuration information; adjusting the first storage space according to the second report configuration information, with a size of the adjusted first storage space obtained by calculation based on the sum of the quantity of the first report configuration information and the quantity of the second report configuration information; and storing the first report information and second report information which is obtained by calculation based on the second resource configuration information and the second report configuration information in the adjusted first storage space.

In some exemplary implementations, the second resource configuration information may include: at least one of a time frequency position of a resource, a period and offset, the number of ports, or a density.

In some exemplary implementations, the second report configuration information may include: at least one of a report identification, a resource configuration identification of an RS resource for channel measurement, a resource configuration identification of an IM resource for interference measurement, a resource configuration identification of an RS resource for interference measurement, a report period and offset, report quality, or codebook configuration.

In some exemplary implementations, the second message includes: at least one of a dedicated configuration request message, an MACCE message, or a DCI message.

In some exemplary implementations, the second report information includes: at least one of a CQI, a layer indicator, a rank indicator, or a precoding indicator.

In some exemplary implementations, the quantity of the second report configuration information refers to the number of reports configured by the second report configuration information.

In some exemplary implementations, in a case where a size of a storage space which is occupied by each piece of the first report information is the same as a size of the storage space which is occupied by each piece of the second report information, the size of the adjusted first storage space is a product of the sum of the quantity of the first report configuration information and the quantity of the second report configuration information, the number of supported carriers, and the size of the second storage space which is occupied by each piece of the first report information.

In some exemplary implementations, the first storage space is allocated and adjusted according to the order of receiving the dedicated configuration request message, the MACCE message, and the DCI message. For example, if the dedicated configuration request message is received first, the first storage space is allocated according to the quantity of the first report configuration information in the dedicated configuration request message, and the size of the first storage space may be a product of the quantity of the first report configuration information in the dedicated configuration request message, the number of supported carriers, and the size of the second storage space which is occupied by each piece of first report information.

Assuming that the first storage space is divided in unit of storage units and that a size of a storage unit is the size of the second storage space which is occupied by each piece of first report information, the number of the storage units included in the first storage space is the quantity of the first report configuration information in the dedicated configuration request message.

Then, if the MACCE message is received, the first storage space is adjusted according to the quantity of the second report configuration information in the MACCE message. The size of the first storage space may be adjusted to be a product of the sum of the quantity of the first report configuration information in the dedicated configuration request message and the quantity of the second report configuration information in the MACCE message, the number of supported carriers, and a size of the second storage space. That is, the number of the storage units included in the first storage space is adjusted to the sum of the quantity of the first report configuration information in the dedicated configuration request message and the quantity of the second report configuration information in the MACCE message. After a semi-persistent report triggered by the MACCE message is ended, the number of the storage units included in the first storage space is adjusted to the quantity of the first report configuration information in the dedicated configuration request message.

If the DCI message is received, the first storage space is adjusted according to the quantity of third report configuration information in the DCI message. The size of the first storage space may be adjusted to be a product of the sum of the quantity of the first report configuration information in the dedicated configuration request message and the quantity of the third report configuration information in the DCI message, the number of supported carriers, and the size of the second storage space. That is, the number of the storage units included in the first storage space is adjusted to the sum of the quantity of the first report configuration information in the dedicated configuration request message and the quantity of the third report configuration information in the DCI message. After a semi-persistent report or a non-periodic report triggered by the DCI message is ended, the number of the storage units included in the first storage space is adjusted to the quantity of the first report configuration information in the dedicated configuration request message.

If the MACCE message and the DCI message are received, the first storage space is adjusted according to the quantity of the second report configuration information in the MACCE message and the quantity of the third report configuration information in the DCI message. The size of the first storage space may be adjusted to be a product of the sum of the quantity of the first report configuration information in the dedicated configuration request message, the quantity of the second report configuration information in the MACCE message, and the quantity of the third report configuration information in the DCI message, the number of supported carriers, and the size of the second storage space. That is, the number of the storage units included in the first storage space is adjusted to the sum of the quantity of the first report configuration information in the dedicated configuration request message, the quantity of the second report configuration information in the MACCE message, and the quantity of the third report configuration information in the DCI message. After a semi-persistent report triggered by the MACCE message and a semi-persistent report or a non-periodic report triggered by the DCI message are ended, the number of the storage units included in the first storage space is adjusted to the quantity of the first report configuration information in the dedicated configuration request message.

In some exemplary implementations, the number of the storage units included in the first storage space is less than or equal to a preset threshold. For example, it is specified by a protocol that the number of reports is 48 at most, so the preset threshold is 48.

In some exemplary implementations, a specific implementation process of storing the first report information and the second report information which is obtained by calculation based on the second resource configuration information and the second report configuration information in the adjusted first storage space is the same as the specific implementation process of storing the first report information obtained by calculation based on the first resource configuration information and the first report configuration information in the first storage space, and thus will not be described in detail here.

According to the report information storage method provided in the implementations of the present disclosure, the size of the first storage space is calculated based on the quantity of the first report configuration information, with no need to allocate excessive storage spaces, so that the storage spaces which need to be allocated are reduced, the risk of stack overflow occurring when a local variable of the resource nodes is applied is reduced, and the utilization of the storage spaces is improved.

In some exemplary implementations, instead of being stored in the resource nodes together with the resource configuration information, the report information is stored separately, so that the risk of stack overflow occurring when a local variable of the resource nodes is applied is reduced, and the utilization of the storage spaces is improved.

For example, in a case where the report information and the resource configuration information are stored together in the resource nodes, a storage space occupied by each resource node is 6564 bytes; and in a case where the report information is stored separately, a storage space occupied by each resource node is 322 bytes. Thus, there is no risk of stack overflow when a local variable of the resource nodes is applied.

For example, in a case where the report information and the resource configuration information are stored together in the resource nodes, at most 32 resources may be configured at a time, and if dual carriers are also supported, a storage space to be allocated to the report information is 32 (resources)×4 (at most 4 reports are associated with each resource)×2 (dual carriers)×6.4 (the size of the second storage space which is occupied by the report information corresponding to each report)=1.6 megabytes (MB). In a case where the report information is stored separately, a storage space which needs to be allocated is 48 (the maximum report number configured for each carrier)×2 (dual carriers)×6.4 (the size of the second storage space which is occupied by the report information corresponding to each report)=0.6MB at most.

In some exemplary implementations, the first storage space is constructed as a hash table, that is, the preset identification corresponding to the report information is mapped to the storage unit identification, which can reduce time complexity of access.

In a second aspect, the present disclosure provides an electronic device, including: at least one processor; and a storage device having stored thereon at least one program which, when executed by the at least one processor, implements the report information storage method according to any one of the above implementations.

The processor is a device having data processing capability, and includes, but is not limited to, a Central Processing Unit (CPU); and the storage device is a device having data storage capability, and includes, but is not limited to, a Random Access Memory (RAM, such as a Synchronous Dynamic RAM (SDRAM), a Double Data Rate SDRAM (DDR SDRAM), etc.), a Read-Only Memory (ROM), an Electrically Erasable Programmable Read-Only Memory (EEPROM), and a flash memory (FLASH).

In some implementations, the processor and the storage device are connected to each other through a bus, and then are connected to other components of a computing device.

In a third aspect, the present disclosure provides a computer-readable medium having stored thereon a computer program which, when executed by a processor, implements the report information storage method according to any one of the above implementations.

It should be understood by those of ordinary skill in the art that the functional modules/units in all or some of the operations, the systems, and the devices in the method disclosed above may be implemented as software, firmware, hardware, or suitable combinations thereof. If implemented as hardware, the division between the functional modules/units stated above is not necessarily corresponding to the division of physical components; for example, one physical component may have a plurality of functions, or one function or operation may be performed through cooperation of several physical components. Some or all of the physical components may be implemented as software executed by a processor, such as a central processing unit, a digital signal processor or a microprocessor, or may be implemented as hardware, or may be implemented as an integrated circuit, such as an application specific integrated circuit. Such software may be distributed on a computer-readable medium, which may include a computer storage medium (or a non-transitory medium) and a communication medium (or a transitory medium). As well known by those of ordinary skill in the art, the term “computer storage medium” includes volatile/nonvolatile and removable/non-removable media used in any method or technology for storing information (such as computer-readable instructions, data structures, program modules and other data). The computer storage medium includes, but is not limited to, an RAM, an ROM, an EEPROM, a flash memory or other memory techniques, a Compact Disc Read Only Memory (CD-ROM), a Digital Versatile Disc (DVD) or other optical discs, a magnetic cassette, a magnetic tape, a magnetic disk or other magnetic storage devices, or any other medium which can be configured to store desired information and can be accessed by a computer. In addition, it is well known by those of ordinary skill in the art that the communication media generally include computer-readable instructions, data structures, program modules, or other data in modulated data signals such as carrier wave or other transmission mechanism, and may include any information delivery medium.

The present disclosure discloses the exemplary implementations using specific terms, but the terms are merely used and should be merely interpreted as having general illustrative meanings, rather than for the purpose of limitation. Unless expressly stated, it is apparent to those of ordinary skill in the art that features, characteristics and/or elements described in connection with a particular implementation can be used alone or in combination with features, characteristics and/or elements described in connection with other implementations. Therefore, it should be understood by those of ordinary skill in the art that various changes in the forms and the details can be made without departing from the scope of the present disclosure of the appended claims.

1. A report information storage method, comprising:
receiving a first message; wherein the first message comprises first resource configuration information and first report configuration information;
allocating a first storage space according to the first report configuration information; wherein a size of the first storage space is obtained by calculation based on a quantity of the first report configuration information; and
storing first report information obtained by calculation based on the first resource configuration information and the first report configuration information in the first storage space.

2. The report information storage method of claim 1, wherein after storing the first report information obtained by calculation based on the first resource configuration information and the first report configuration information in the first storage space, the method further comprises:
receiving a second message; wherein the second message comprises second resource configuration information and second report configuration information;
adjusting the first storage space according to the second report configuration information, a size of the adjusted first storage space being obtained by calculation based on a sum of the quantity of the first report configuration information and a quantity of the second report configuration information; and
storing the first report information and second report information which is obtained by calculation based on the second resource configuration information and the second report configuration information in the adjusted first storage space.

3. The report information storage method of claim 1, wherein the size of the first storage space is a product of the quantity of the first report configuration information, a number of supported carriers, and a size of a second storage space which is occupied by each piece of first report information.

4. The report information storage method of claim 1, wherein the first storage space is different from a storage space allocated to a resource node.

5. The report information storage method of claim 1, wherein the first message comprises at least one of:
a dedicated configuration request message, a Media Access Control Control Element (MACCE) message, or a Downlink Control Information (DCI) message.

6. The report information storage method of claim 1, wherein storing the first report information obtained by calculation based on the first resource configuration information and the first report configuration information in the first storage space comprises:
calculating a first storage unit identification by a hash function based on a preset identification corresponding to the first report information; and
in a case where a storage unit corresponding to the first storage unit identification is idle, storing the first report information in the storage unit corresponding to the first storage unit identification; wherein the first storage space is divided into at least one storage unit, and a size of a storage unit of the at least one storage unit is a size of a second storage space which is occupied by one piece of first report information in the first storage space.

7. The report information storage method of claim 6, wherein calculating the first storage unit identification by the hash function based on the preset identification corresponding to the first report information comprises:
taking a remainder obtained by dividing the preset identification by a number of storage units included in the first storage space as the first storage unit identification.

8. The report information storage method of claim 6, wherein in a case where the storage unit corresponding to the first storage unit identification is occupied, storing the first report information obtained by calculation based on the first resource configuration information and the first report configuration information in the first storage space further comprises:
calculating a second storage unit identification by a rehash function based on the preset identification corresponding to the first report information; and
in a case where a storage unit corresponding to the second storage unit identification is idle, storing the first report information in the storage unit corresponding to the second storage unit identification.

9. The report information storage method of claim 8, wherein calculating the second storage unit identification by the rehash function based on the preset identification corresponding to the first report information comprises:
adding i to the preset identification; wherein i is an integer greater than or equal to 1; and
taking a remainder obtained by dividing the preset identification with addition of i by a number of storage units included in the first storage space as the second storage unit identification.

10. The report information storage method of claim 8, wherein in a case where the storage unit corresponding to the second storage unit identification is occupied, storing the first report information obtained by calculation based on the first resource configuration information and the first report configuration information in the first storage space further comprises:
performing an operation of calculating a third storage unit identification by the rehash function based on the preset identification corresponding to the first report information until a storage unit corresponding to a calculated storage unit identification is idle.

11. An electronic device, comprising:
at least one processor; and
a storage device having stored thereon at least one program which, when executed by the at least one processor, implements a report information storage method comprising:
receiving a first message; wherein the first message comprises first resource configuration information and first report configuration information;
allocating a first storage space according to the first report configuration information; wherein a size of the first storage space is obtained by calculation based on a quantity of the first report configuration information; and
storing first report information obtained by calculation based on the first resource configuration information and the first report configuration information in the first storage space.

12. A non-transitory computer-readable medium having stored thereon a computer program which, when executed by a processor, implements the report information storage method comprising:
receiving a first message; wherein the first message comprises first resource configuration information and first report configuration information;
allocating a first storage space according to the first report configuration information; wherein a size of the first storage space is obtained by calculation based on a quantity of the first report configuration information; and
storing first report information obtained by calculation based on the first resource configuration information and the first report configuration information in the first storage space.

13. The report information storage method of claim 2, wherein the size of the first storage space is a product of the quantity of the first report configuration information, a number of supported carriers, and a size of a second storage space which is occupied by each piece of first report information.

14. The report information storage method of claim 2, wherein the first storage space is different from a storage space allocated to a resource node.

15. The report information storage method of claim 2, wherein the first message comprises at least one of:
a dedicated configuration request message, a Media Access Control Control Element (MACCE) message, or a Downlink Control Information (DCI) message.

16. The report information storage method of claim 2, wherein storing the first report information obtained by calculation based on the first resource configuration information and the first report configuration information in the first storage space comprises:
calculating a first storage unit identification by a hash function based on a preset identification corresponding to the first report information; and
in a case where a storage unit corresponding to the first storage unit identification is idle, storing the first report information in the storage unit corresponding to the first storage unit identification; wherein the first storage space is divided into at least one storage unit, and a size of a storage unit of the at least one storage unit is a size of a second storage space which is occupied by one piece of first report information in the first storage space.

17. The report information storage method of claim 16, wherein calculating the first storage unit identification by the hash function based on the preset identification corresponding to the first report information comprises:
taking a remainder obtained by dividing the preset identification by a number of storage units included in the first storage space as the first storage unit identification.

18. The report information storage method of claim 16, wherein in a case where the storage unit corresponding to the first storage unit identification is occupied, storing the first report information obtained by calculation based on the first resource configuration information and the first report configuration information in the first storage space further comprises:
calculating a second storage unit identification by a rehash function based on the preset identification corresponding to the first report information; and
in a case where a storage unit corresponding to the second storage unit identification is idle, storing the first report information in the storage unit corresponding to the second storage unit identification.

19. The report information storage method of claim 18, wherein calculating the second storage unit identification by the rehash function based on the preset identification corresponding to the first report information comprises:
adding i to the preset identification; wherein i is an integer greater than or equal to 1; and
taking a remainder obtained by dividing the preset identification with addition of i by a number of storage units included in the first storage space as the second storage unit identification.

20. The report information storage method of claim 18, wherein in a case where the storage unit corresponding to the second storage unit identification is occupied, storing the first report information obtained by calculation based on the first resource configuration information and the first report configuration information in the first storage space further comprises:
performing an operation of calculating a third storage unit identification by the rehash function based on the preset identification corresponding to the first report information until a storage unit corresponding to a calculated storage unit identification is idle.
